(19) United States
(12) Patent Application Publication
(10) Pub. No.: US 2017/0001339 A1
(43) Pub. Date: Jan. 5, 2017

(54) MEMBRANE-ASSISTED PREFORMING OF PLASTIC SEMI-FINISHED PRODUCT

(71) Applicant: Compagnie Plastic Omnium, Lyon (FR)

(72) Inventors: Damien BOISSON, Lyon (FR); Emillien HUMMER, Villeurbanne (FR)

(73) Assignee: Compagnie Plastic Omnium, Lyon (FR)

(21) Appl. No.: 15/107,154

(22) PCT Filed: Dec. 22, 2014
(86) PCT No.: PCT/FR2014/053513

§ 371 Date: Jun. 22, 2016

(30) Foreign Application Priority Data
Dec. 24, 2013 (FR) 1363567

(51) Int. Cl. B29C 33/68; B29C 51/44; B29C 70/46; B29C 51/10

(52) U.S. Cl. CPC B29C 33/68; B29C 51/10; B29C 51/44; B29C 70/46; B29K 2105/0872

(57) ABSTRACT

Method for preforming a plastic semi-finished product, wherein: at least one anti-adhesive membrane is positioned facing a wall of a preforming mould; the plastic semi-finished product is positioned facing the anti-adhesive membrane so that the anti-adhesive membrane is positioned between the semi-finished product and the wall; pressure is applied to press the semi-finished product against the wall of the preforming mould, in order to give a shape to the semi-finished product; pressure is removed and the preformed part is ejected from the wall; and the preformed part is removed from the mould.

The invention relates to the field of manufacturing composite materials using moulding methods with closed moulds.

In particular, the invention relates to a method for preforming a plastic semi-finished product used to manufacture a plastic product.

In the automotive field, for example, numerous parts must combine mechanical strength and low weight.

To do this, it is known that steel parts can be replaced by thermosetting or thermoplastic plastic parts.

Various methods for moulding plastic parts are known:
compression (thermosetting materials such as SMC);
thermoforming (compression with a thermoplastic material);
injection (for thermoplastic materials).
resin transfer method (RTM)

It is known to use reinforced (thermosetting or thermoplastic) plastic materials. These materials are composed of reinforcement fibres mixed with a polymer resin. These reinforcements include glass or carbon fibres for example. These fibres may be cut or continuous.

Depending on the plastic materials used and the moulding method used, a preform of the part may have to be produced by preforming the semi-finished product before introducing it in the manufacturing mould.

For example, it is known to use SMC with a high reinforcement content, in particular greater than or equal to 50% by weight, to manufacture semi-structural composite parts.

However, since these SMC flanks have a higher fibre content that conventional SMC flanks, the plastic material (resin) does not flow as well in the manufacturing mould. These SMC flanks must therefore be preformed to produce parts of complex shape. Thus, a step of preforming the SMC flank is introduced between cutting the SMC flank and moulding to obtain the finished part.

Preforming consists in shaping the semi-finished product using special equipment, different from the equipment required for moulding the finished part. For example, the preforming equipment does not necessarily include the final shapes of the part, unlike the manufacturing mould. Furthermore, the preforming equipment generally operates under pressure, temperature and time conditions different from those used to mould the finished part. For example, the temperature for preforming the preform is less than that used when moulding the finished part. Since the temperature is lower than that in the manufacturing mould, the resin does not flow or polymerise.

Various preforming techniques are known. For example, the “vacuum preforming” method is known. This method uses a membrane, called vacuum bag, placed on the SMC flank. A vacuum is then produced, pressing the bag against the wall of the mould and taking with it the SMC flank placed between the bag and the mould.

Another compression preforming method (called cold stamping) is known, in which the plastic semi-finished product is placed in punch-die type preforming equipment. The equipment is then closed to apply pressure on the semi-finished product, while remaining at moderate temperature, such as ambient temperature.

Irrespective of the method used, however, this preforming step has a major disadvantage: the preform adheres to the surface of the preforming means after shaping. This adhesion makes it difficult for the robot to pick up the preform in order to insert it in the manufacturing mould. This adhesion makes it difficult to eject the preform out of the mould. Furthermore, this adhesion leads to clogging of the preforming means.

Lastly, if preforming is carried out using punch-die type equipment, the SMC flank may tear.

The invention aims to remedy these disadvantages by providing a method for preforming a plastic semi-finished product, in which anti-adhesive membranes are inserted between the finished product and the mould walls. The method according to the invention therefore comprises the following steps:
at least one anti-adhesive membrane is positioned facing a wall of a preforming mould;
the plastic semi-finished product is positioned facing the anti-adhesive membrane so that the anti-adhesive membrane is positioned between the semi-finished product and the wall;
pressure is applied to press the semi-finished product against the wall of the preforming mould, in order to give a shape to the semi-finished product;
the pressure is removed and the preformed part is ejected from the wall; and
the preformed part is removed from the mould.

By inserting membranes between the mould and the semi-finished product, the preformed semi-finished product does not adhere to the walls of the preforming mould.

Lastly, the use of membranes according to the method limits the damage to the preforms during compression.

Spare membranes can also be used to clean or repair worn membranes without blocking the preforming mould.

Preferably, the anti-adhesive membrane is anti-adhesive with respect to the wall of the preforming mould and the semi-finished product.

The membrane may contain silicone and/or stearates and/or fats and/or maleic anhydrides.

The preformed part can be ejected from the mould wall by separating the membrane from the wall.

For example, the membrane can be separated from the wall by applying pressure between the membrane and the wall. The membrane can also be separated from the wall by the membrane returning to its original shape.

According to one embodiment, a vacuum is created between the membrane and the wall before closing the mould in order to press the membrane on the wall, the membrane is then separated from the wall by reintroducing air between the membrane and the wall.

The membrane can be flat or have the shape of the wall.

According to one embodiment, a punch-die type preforming mould is used, the first membrane being located between the semi-finished product and a first wall of the mould, and a second anti-adhesive membrane being located between the semi-finished product and a second wall of the mould.

The second membrane may contain silicone and/or stearates and/or fats and/or maleic anhydrides.

According to one embodiment, the temperature inside the preforming mould is ambient temperature.

Lastly, according to the invention, an SMC type thermosetting material can be used as plastic material.

The invention will be better understood on reading the accompanying figures, which are given solely by way of example and not limiting in any way, in which:

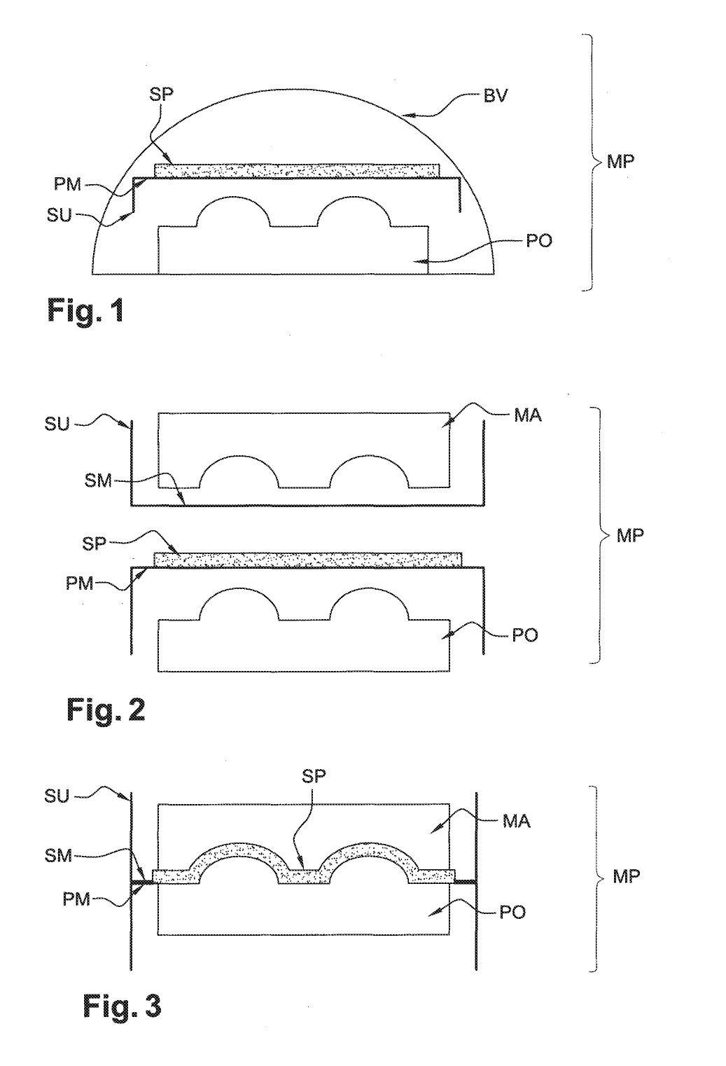

FIG. 1 illustrates, for a first embodiment, introduction of the plastic semi-finished product (SP) and of an anti-adhesive membrane (PM) in the preforming mould (MP).

FIG. 2 illustrates, for a second embodiment, introduction of the plastic semi-finished product (SP) and of the two anti-adhesive membranes (PM, SM) in the preforming mould (MP).

FIG. 3 illustrates the closed state of the preforming mould (MP), when the punch (PO) presses the die (MA).

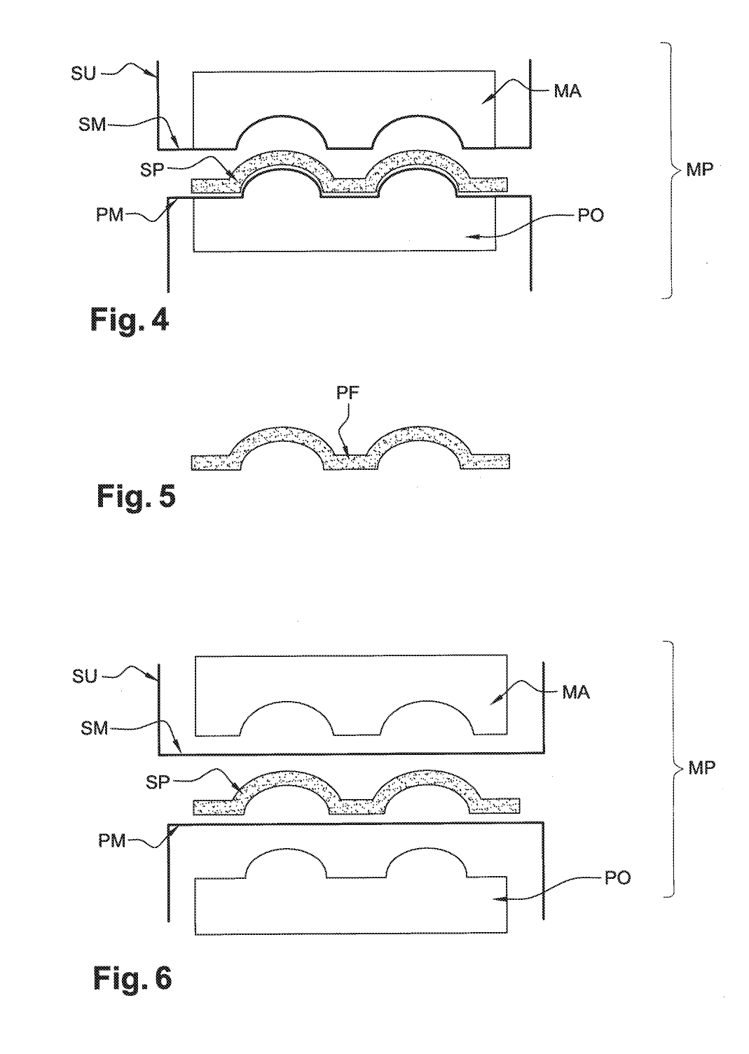

FIG. 4 illustrates the preforming mould (MP) as it starts to open.

FIG. 5 illustrates the preform (PF) taken out of the preforming mould (MP).

FIG. 6 illustrates the embodiment in which the preformed part (PF) is ejected from the die (MA) by separating the first membrane (PM) from the die (MA).

We now refer to FIG. 1, which describes the various steps of the method according to the invention. This method for preforming a plastic semi-finished product (SP) comprises the following steps:
at least one anti-adhesive membrane (PM) is positioned facing a wall of a preforming mould (MP);
the plastic semi-finished product (SP) is positioned facing the anti-adhesive membrane (PM) so that the anti-adhesive membrane (PM) is positioned between the semi-finished product (SP) and the wall;
pressure is applied to press the semi-finished product (SP) against the wall of the preforming mould (MP), in order to give a shape to the semi-finished product (SP);
pressure is removed and the preformed part (PF) is ejected from the wall; and
   the preformed part, or preform (PF), is removed from the mould.

The anti-adhesive membrane (PM) is attached to a membrane support (SU). The support may be a frame to which the membrane is attached (using metal eyelets for example).

This support (SU) may be attached to the mould. It may also be vertically and/or horizontally movable. The support (SU) may for example be mounted on movable means, in order to be displaced. During production therefore, the frame can be loaded with a semi-finished product (SP) and a membrane, while the mould preforms another flank of semi-finished product (SP). When the mould is open, or when the vacuum under the vacuum bag has been released, the support is moved so as to take the preform on the membrane out of the mould. Another support including a semi-finished product flank and a membrane is then brought to introduce the semi-finished product and the membrane in the mould.

The anti-adhesive membrane (PM) can be positioned facing the wall of the preforming mould (MP) on each moulding cycle, either on a support fixed to the mould or on a movable support.

According to a preferred embodiment, the anti-adhesive membrane (PM) is positioned permanently on or above the mould wall.

The anti-adhesive membrane (PM) can be introduced in the mould (MP) with a flat shape. In this case, it is deformed during pressurisation (when the mould is closed or when a vacuum is applied).

The anti-adhesive membrane (PM) can also be introduced in the mould (MP) with the same shape as that of the mould wall with which it is in contact.

According to a first embodiment (FIG. 1), a “vacuum preforming” type method is used, in which the pressure is applied by producing a vacuum under a vacuum bag (BV) placed against the semi-finished product on the side opposite the mould wall, such that the vacuum bag presses the semi-finished product against the mould wall. According to this embodiment, the pressure stops when the vacuum is removed.

FIG. 1 illustrates introduction of the plastic semi-finished product (SP) and of an anti-adhesive membrane (PM) in the preforming mould (MP).

According to a second embodiment (FIGS. 2 to 5), a “compression preforming” type method is used, in which pressure is applied when the punch-die type mould is closed. According to this embodiment, the pressure stops when the punch-die type mould is opened.

According to this embodiment, it is also preferable to use a second membrane (SM) since each side of the semi-finished product is in contact with a wall of the mould: the first membrane (PM) being located between the semi-finished product (SP) and a first wall (PO) of the mould (MP), and the second anti-adhesive membrane (SM) being located between the semi-finished product (SP) and a second wall (MA) of the mould (MP).

The compression preforming method according to this second embodiment therefore comprises the following steps:

at least the first anti-adhesive membrane (PM) is positioned facing the punch (PO) of the preforming mould (MP);

at least the second anti-adhesive membrane (SM) is positioned facing the die (MA) of the preforming mould (MP);

the plastic semi-finished product (SP) is positioned facing the two anti-adhesive membranes (PM, SM), such that the semi-finished product (SP) is in between the two membranes (PM, SM);

the preforming mould (MP) is closed;

the mould is opened and the preformed part (PF) is ejected; and

the preformed part, or preform (PF), is removed from the mould.

FIG. 2 illustrates introduction of the plastic semi-finished product (SP) and of the two anti-adhesive membranes (PM, SM) in the preforming mould (MP).

According to a variant of the second embodiment, the second membrane (SM) is permanently introduced in the mould.

The second anti-adhesive membrane (SM) is also fixed to a membrane support (SU), of the same type as that of the first membrane (PM).

The second anti-adhesive membrane (SM) can be inserted between the wall of the preforming mould (MP) and the semi-finished product (SP) each time the mould is used, either on a support fixed to the mould or on a movable support.

According to a preferred embodiment, the second anti-adhesive membrane (SM) is positioned permanently in the mould.

The second anti-adhesive membrane (SM) can be introduced in the mould (MP) with a flat shape. In this case, it is deformed during pressurisation (when the mould is closed).

The second anti-adhesive membrane (SM) can also be introduced in the mould (MP) with the same shape as that of the mould wall with which it is in contact.

FIG. 3 illustrates the closed state of the preforming mould (MP), when the punch (PO) presses the die (MA).

FIG. 4 illustrates the preforming mould (MP) as it starts to open.

FIG. 5 illustrates the preform (PF) taken out of the preforming mould (MP).

A preforming mould (MP) comprises a fixed die (MA) and a movable punch (PO). This type of mould does not necessarily include a heating element, since the aim is not to mould the finished part but to create a preform which will be introduced in a manufacturing mould.

Due to their elongation percentage, the membranes PM and SM can adapt to the shapes of the mould.

By using a membrane capable of stretching when subjected to the same stresses as the semi-finished product in the preforming equipment, the preform can be demoulded more easily, the part being ejected after opening the mould.

Preferably, the membrane MP is elastic, allowing it to return to its original shape.

The membranes PM and SM are anti-adhesive membranes for preforming temperatures and materials of the semi-finished product (SP). These temperatures generally lie between 0° C. and 150° C., preferably between ambient temperature and 100° C., and even more preferably between ambient temperature and 50° C. Thus:
these membranes do not adhere to the mould walls;
these membranes do not adhere to the semi-finished product flank.

Adhesion refers to all physico-chemical phenomena which occur when two materials are placed in close contact, to create a mechanical resistance to separation. Once contact has been made, the energy required to achieve the separation is called the adhesion energy.

In a known manner, adhesion is governed by four types of phenomenon: physical, mechanical, chemical and diffusive.

Thus, depending on the semi-finished product used and the material forming the mould wall, specialists can determine which material meets this anti-adhesive requirement.

For example, membranes (PM, SM) containing silicone can be used in the method according to the invention, since they are known for their anti-adhesive properties with respect to plastic resins and plastic preforming moulds.

These membranes may also contain stearates, fats (soaps, etc.), maleic anhydrides, etc. as anti-adhesive agent.

According to one embodiment, the membranes are silicone membranes of thickness 1 mm and 5 mm.

According to a third embodiment, the membrane PM is used to eject the preform (PF) from the mould (MP), as shown on FIG. 6 for the second embodiment.

Thus, according to this embodiment, the method comprises a step during which the preformed part (PF) is ejected from the die (MA) by separating the membrane PM from the die (MA). FIG. 6 shows that the first membrane (PM) is separated from the die (MA), ejecting the preform (PF).

According to an embodiment, the membranes are membranes containing silicone and having an elongation percentage of between 100% and 800%.

This membrane PM can be separated from the mould wall by applying pressure between the membrane (PM) and the wall (MA, PO) with which it is in contact.

The pressure can be applied by local ejectors, with in this case the membrane distributing the forces applied by these ejectors.

The pressure can also be applied by injecting a gas such as air between the mould wall and the membrane PM. Due to its elastic property, the membrane stretches, ejecting the preform from the mould.

This membrane (PM) can also be separated from the die (MA) by the first membrane (PM) returning to its original shape. In this case, the membrane PM also requires the following property: on returning to its rest state, the membrane returns to its original shape. Elastomer, silicone and latex membranes have this property.

According to a variant of this embodiment, the vacuum between the first membrane (PM) and the die (MA) is created before closing the mould (MP). Unlike the vacuum preforming method, the aim is not to deform the semi-finished product (SP) to be preformed. This operation is carried out to press the first membrane (PM) against the die (MA), thereby preventing the part from sticking to the mould. In this variant of the invention, this operation also prepares for ejection of the preform (PF). After opening the mould, the first membrane (PM) is separated from the die (MA) by reintroducing air between the first membrane (PM) and the die (MA).

According to one embodiment, and depending on the type of plastic semi-finished product (SP), the inside of the preforming mould (MP) is maintained at ambient temperature while preforming the part.

The plastic semi-finished product (SP) can be made of thermoplastic or thermosetting material. For example, a thermosetting material of type SMC can be used.

According to a preferred preform production embodiment, the following steps are performed:
i. a loading plan is produced outside the mould, by stacking at least a semi-finished product and a first anti-adhesive membrane (PM), on a movable support;
ii. the semi-finished product and the first anti-adhesive membrane (PM) are introduced by moving the support such that the first anti-adhesive membrane (PM) is positioned between one of the mould walls and the semi-finished product;
iii. a second anti-adhesive membrane (SM) is positioned permanently between the other movable wall of the preforming mould (MP) and the semi-finished product;
iv. the preforming mould (MP) is closed and at least one part of a new loading plan is produced simultaneously outside the mould on a second support (a new loading plan is produced at least partially in hidden time while moulding);
v. the mould is opened and the preformed part (PF) is ejected;
vi. the preformed part, or preform (PF), is removed from the mould; then
vii. step iii is repeated with the second support.

1. Method for preforming a plastic semi-finished product, wherein:
at least one anti-adhesive membrane is positioned facing a wall of a preforming mould;
the plastic semi-finished product is positioned facing the anti-adhesive membrane so that the anti-adhesive membrane is positioned between the semi-finished product and the wall;
pressure is applied to press the semi-finished product against the wall of the preforming mould, in order to give a shape to the semi-finished product;
pressure is removed and a preformed part is ejected from the wall; and
the preformed part is removed from the mould.

2. Method according to claim 1, wherein the anti-adhesive membrane is anti-adhesive with respect to the wall of the preforming mould and the semi-finished product.

3. Method according to claim 1, wherein the membrane contains silicone and/or stearates and/or fats and/or maleic anhydrides.

4. Method according to claim 1, wherein the preformed part is ejected from the mould wall by separating the membrane from the wall.

5. Method according to claim 1, wherein the membrane is separated from the wall by applying pressure between the membrane and the wall.

6. Method according to claim 1, wherein the membrane is separated from the wall by the membrane returning to its original shape.

7. Method according to claim 1, wherein a vacuum is created between the membrane and the wall before closing the mould in order to press the membrane on the wall, the membrane is then separated from the wall by reintroducing air between the membrane and the wall.

8. Method according to claim 1, wherein the membrane is flat or has the shape of the wall.

9. Method according to claim 1, wherein a punch-die type preforming mould is used, at first membrane being located between the semi-finished product and a first wall of the mould, and a second anti-adhesive membrane being located between the semi-finished product and a second wall of the mould.

10. Method according to claim 9, wherein the second membrane contains silicone and/or stearates and/or fats and/or maleic anhydrides.

11. Method according to claim 1, wherein the temperature inside the preforming mould is ambient temperature.

12. Method according to claim 1, wherein an SMC type thermosetting material is used as plastic material.
